(19) United States
(12) Patent Application Publication
(10) Pub. No.: US 2024/0301272 A1
(43) Pub. Date: Sep. 12, 2024

(54) WATER-DISPERSIBLE POLYMER POWDER COMPOSITIONS FOR CEMENTING IN SUBTERRANEAN FORMATION, THEIR MANUFACTURE AND USE

(71) Applicant: BASF SE, Ludwigshafen am Rhein (DE)

(72) Inventors: Christian SCHMIDTKE, Trostberg (DE); Andrea ASSMANN, Trostberg (DE); Martin WINKLBAUER, Trostberg (DE); Lisa WOLFERSTETTER, Trostberg (DE)

(21) Appl. No.: 18/283,229

(22) PCT Filed: Mar. 17, 2022
(86) PCT No.: PCT/EP2022/056923

§ 371 Date: Sep. 21, 2023

(30) Foreign Application Priority Data
Mar. 23, 2021 (EP) 21164356.4

(51) Int. Cl. C09K 8/467; C04B 18/02; C04B 24/16; C04B 24/22; C04B 24/26; C04B 24/30; C04B 24/32; C04B 28/02; C04B 103/00; C04B 103/40; E21B 33/14

(52) U.S. Cl. CPC C09K 8/467; C04B 18/022; C04B 24/163; C04B 24/166; C04B 24/22; C04B 24/226; C04B 24/2676; C04B 24/305; C04B 24/32; C04B 28/02; E21B 33/14; C04B 2103/0057; C04B 2103/406

(57) ABSTRACT

Water-dispersible polymer powder composition for use as additive in cementing in subterranean formations comprising at least particles of a styrene-butadiene polymer, a water-soluble polymer, and a non-ionic emulsifier, wherein the styrene-butadiene polymer particles are at least partly covered by and/or embedded in a composition comprising at least the water-soluble polymer, process of making such compositions, by spray-drying an aqueous dispersion comprising said particles of a styrene-butadiene polymer and a water-soluble polymer, wherein at least one non-ionic emulsifier is added before or after spray-drying, and the use of such water-dispersible polymer powder compositions for cementing in subterranean formations penetrated by at least a well bore.

The present invention relates to water-dispersible polymer powder compositions for use as additive in cementing in subterranean formations comprising at least particles of a styrene-butadiene polymer, a water-soluble polymer, and a non-ionic emulsifier, wherein the styrene-butadiene polymer particles are at least partly covered by and/or embedded in a composition comprising at least the water-soluble polymer. It furthermore relates to a process of making such compositions, by spray-drying an aqueous dispersion comprising said particles of a styrene-butadiene polymer and a water-soluble polymer, wherein at least one non-ionic emulsifier is added before or after spray-drying. It furthermore relates to the use of such water-dispersible polymer powder compositions for cementing in subterranean formations penetrated by at least a well bore.

After drilling a section of a well, such as an oil well, gas well or water well, the wells are stabilized by inserting a steel casing into the wellbore and placing cement into the annulus between the casing and the wall of the wellbore. The cement layer supports the casing string in the wellbore and also seals the wellbore from the subterranean formation so that no formation fluids or gas from the formation can enter into the wellbore. Typically, drilling a wellbore comprises drilling a plurality of sections, and after each of the sections, a casing is placed into the wellbore and cemented, wherein the diameter of the casing decreases from section to section.

In course of a cementing operation, cement is pressed through the casing to the bottom of the wellbore where it enters into the annulus between the casing and the wellbore wall where it streams back towards the surface, thereby filling the annulus completely.

The demands on cement formulations for cementing wellbores are high. Cement formulations for cementing oil wells should not set too quickly but the cement slurry should act as a liquid and remain pumpable until the cement has been placed into the annulus between the casing and the wall of the wellbore. The temperatures on bottom of a wellbore may be significantly above ambient temperatures and the cement composition has to work also at such temperatures. Furthermore, a cement column placed in the annulus and the wall of the wellbore may have a length from 10 m to 10000 m which may give rise to a significant hydrostatic pressure as long as the cement has not set. Said hydrostatic pressure may cause a filtration process, wherein water of the cement formulation penetrates into the formation while the cement particles are left behind on the wellbore wall. Such an effect is also known as “fluid loss”. The layer of cement particles on the wellbore wall is also known as “filter cake”. Fluid loss may significantly diminish the strength of the cement after setting. Also, gas penetrating from the formation into a cement formulation which has not yet set may diminish the strength of the cement after setting.

It is known in the art to use additives for cement formulations in order to prevent fluid loss and/or gas migration. Such additives may act by plugging pores in the formation and/or decreasing the permeability of the filter cake. Examples of anti-fluid-loss additives comprise high molecular weight water-soluble polymers such as polyvinylalcohol, hydroxyethyl cellulose, carboxymethyl hydroxyethyl cellulose, polyvinylpyrrolidone or particulate additives, aqueous polymer dispersions such as latices or crosslinked polymers. Styrene-butadiene latices are widely distributed in oilwell cementing.

EP 1 673 434 A1 discloses an agent for fluid loss control consisting essentially of styrene-butadiene latex and a high molecular weight water-soluble polymer.

U.S. Pat. No. 4,537,918 discloses a cement slurry composition for cementing oil wells and inhibiting pressure gas channeling comprising a hydraulic cement, water, a styrene-butadiene latex and a latex stabilizer selected from the group of lignosulfonates, sulfonic acid or sulfite modified melamine-formaldehyde resins, formaldehyde-sulfonate-naphthalene resins, and condensation products of bi-nuclear sulfonated phenols and of formaldehyde.

EP 0 189 950 A discloses cement slurry compositions for cementing oil, gas, and geothermal wells comprising a styrene-butadiene latex and an additive for imparting right-angle set properties to cement slurries consisting of an ammonium salt of sulfonated nonylphenoxy(polyethyleneoxy)ethanol.

Aqueous latex dispersions need to be added to the cement formulation when the cement is mixed with water for use. Using aqueous dispersions as fluid loss additive has several drawbacks. Aqueous dispersions may be subject to frost damages, i.e. irreversible coagulation may occur when used in cold environments, such as for example arctic environment. Also ageing processes may give rise to coagulation. Aqueous dispersions may also be subject to biological decomposition and it may be necessary to add biocides. Because aqueous dispersions comprise a significant amount of water, the transports costs are higher as compared to polymer powders only. It is desirable to have available styrene-butadiene latex for well cementing as dry, re-dispersible polymer powders which can be mixed with dry cement thereby obtaining a dry cement formulation which already comprises the fluid loss additive.

Redispersible styrene-butadiene copolymer powders for civil construction applications like repair mortar, tile adhesives or gypsum are commercially available, for example as Axilat® PSB 150.

WO 2008/059037 A1 discloses dry cement formulations for wellbore cementing comprising cement, optionally a quartz powder, a water-dispersible powder on basis of polymer dispersions, and optionally further additives. The polymer powder may be selected from styrene-butadiene polymers, styrene-acrylate polymers, acrylates or vinyl-versatate-acrylate polymers. The water-dispersible powders are made by drying aqueous polymer dispersions, preferably by spray drying, however any details about the manufacturing process are missing in the specification, including the examples. The document mentions that spray-drying aids may be used in an amount of up to 10 wt.-% relating to the polymer dispersion, however, the specification mentions no specific examples of spray-drying aids.

EP1 950 266 A1 discloses solid gas migration control additives based on latex powders for cementing applications. The latex powder preferably may be a vinyl acetate latex powder or a styrene-butadiene latex. The document mentions, that the products may be made by spray-drying but does not mention any details about the process.

WO 2014/093418 A1 discloses water-redispersible polymer powders comprising a co-dried admixture of a water-insoluble film-forming polymer, a colloidal stabilizer and rubber particles, for example waste rubber. Examples of water-insoluble film-forming polymers comprise acrylic polymers, ethylene-vinylacetate copolymers, or styrene-butadiene copolymers. The document also discloses a dry mix formulation comprising a hydraulic binder and the abovementioned polymer powder. The mixture may be used for cement based tile adhesives. Cementing wells has not been disclosed. The polymer powders may be prepared by drying a mixture of an aqueous dispersion of the water-insoluble film-forming polymer, a colloidal stabilizer and rubber particles, for example by spray drying. No details about the spray drying process are disclosed.

U.S. Pat. No. 5,922,796 A discloses a water-redispersible pulverulent compositions comprising a powder of one or more water-insoluble, film-forming polymers, a non-ionic polyoxy-alkylenated surfactant and a water-soluble polyelectrolyte and its use for cements. The document does not disclose cementing wells.

WO 98/03576 A1 discloses the use of phenolsulfonic acid-formaldehyde condensation products as drying aids for drying aqueous polymer dispersions, for example of acrylate dispersions or styrene-butadiene dispersions. Drying may be carried out by spray-drying. The polymer powders may be used in hydraulic setting compositions, paints, lacquers, adhesives, coating compositions or synthetic-resin renders. Well cementing has not been disclosed. WO 98/03577 A1 is similar to WO 98/03576 A1 and discloses the use of naphthalinesulfonic acid-formaldehyde condensation products as drying aids for drying aqueous polymer dispersions.

US 2020/0207671 A1 discloses a process for producing a redispersible dispersion powder, comprising mixing at least an aqueous dispersion, a polyacid comprising ethylenically unsaturated monomers comprising a sulfonic acid group, and an additive comprising a polyoxyalkylene group. The polymer dispersion may be selected from styrene-acrylate copolymers, styrene-butadiene copolymers, acrylate copolymers or ethylene-vinylacetate copolymers. The document also discloses the use of such redispersible dispersion powders in building material compositions for example for tile adhesives or tile join mortars.

Stefan Baueregger, Margarita Perello and Johann Planck report about making redispersible polymer powders, in particular powders of carboxylated styrene-butadiene polymers, in “Influence of carboxylated styrene-butadiene latex copolymer on Portland cement hydration”, Cement and Concrete Composites 63 (2015) 42-50 and in “Influence of anti-caking agent kaolin on film formation of ethylene-vinylacetate and carboxylated styrene-butadiene latex polymers”, Concrete and Cement Research 58 (2014), 112-120. The powders are made by spray-drying of aqueous polymer dispersions in the presence of protective colloids such as polyvinylalcohol and anti-caking agent, such as clay, silica, calcium carbonate or kaolin. The documents mention the use of drymix mortars comprising such powders in tile adhesives, tile grouts or external thermal insulation composite systems (ETICS). Cementing oilwells has not been mentioned.

EP 1 021 483 A2 discloses a water-redispersible pulverent composition comprising at least a water-insoluble film-forming polymer, which may be selected from a list comprising styrene-butadiene, and a naphthalenesulphonate. The water-redispersible pulverent may optionally further comprise a polyphenol, which may be selected from phenol sulfonic acid—formaldehyde condensates, an ethoxylated non-ionic surfactants and an inorganic filler. The water-redispersible pulvurent composition may be used in different fields, such as in the oil industry, however wellbore cementing is not specifically mentioned.

EP 1 184 406 A2 discloses a process for preparing polymer powders, preferably based for on styrene-butadiene copolymers, via spray drying an aqueous dispersion of a film-forming polymer, which may be styrene-butadiene copolymers, a drying assistant selected from salts of oligomeric arylsulfonic acid-formaldehyde condensates and one anionic emulsifiers. The anionic emulsifier must be present in the aqueous polymer dispersion, before spray drying. A non-ionic emulsifier may also be used, but only in addition to the anionic emulsifier already mentioned. The polymer powders disclosed in EP 1 184 406 A2 are suitable as cobinders in binding mineral building materials and their formulations. Cementing of oilwells is not mentioned.

The demands on hydraulic binders to be used in the civil construction industry and those to be used in the oil industry for cementing oilwells are very different. In civil construction applications a fast gel strength development and a high adhesive strength often is necessary. By the way of example, tiles should adhere to the wall and remain in place even if the tile adhesive has not yet been set. By contrast, hydraulic cement compositions for oilwell cementing should have a low viscosity for a significant time after mixing so that they are pumpable and can be properly placed into the annulus between the casing and the wall of the wellbore before the hydraulic cement composition sets. A rectangular setting behavior is highly desirable, i.e. that the gel strength of the hydraulic cement composition for a certain time, for example a few hours, does not increase much and is pumpable. However, as soon as the cement slurry is placed in the annulus, fast gel build-up and short transition time from a liquid cement slurry to a cement slurry which can't be penetrated by intruding gas from the formation is highly desirable.

It was the object of the present invention, to provide improved water-dispersible polymer powders for use as anti-fluid-loss additives in well cementing, in particular oilwell cementing which simultaneously improve the setting behavior of the hydraulic cementing composition.

Accordingly, in a first embodiment of the invention a water-dispersible polymer powder composition (P) for use as additive in cementing in subterranean formations has been found, comprising at least
50 to 98.5 wt.-% of particles of a styrene-butadiene polymer (A),
1 to 20 wt.-% of at least one water-soluble polymer (B), selected from the group of phenol sulfonic acid-formaldehyde condensates, naphthalene sulfonic acid-formaldehyde condensates, melamine-formaldehyde condensates, formaldehyde-acetone-sulfite condensates, and copolymers comprising at least ethylenically unsaturated monomers comprising sulfonic acid groups and ethylenically unsaturated monomers comprising carboxylic acid groups,
0.5 to 10 wt.-% of at least one non-ionic emulsifier (C),
wherein the amounts relate to the total of all components of the composition (P), and
wherein the styrene-butadiene polymer particles are at least partly covered by and/or embedded in a composition (X) comprising at least the water-soluble polymer (B).

In a second embodiment of the invention, a process for making the water-dispersible polymer powder composition (P) as mentioned above has been found, comprising spray-drying an aqueous polymer dispersion in the presence of a spray-drying aid, wherein process comprises at least the following process steps:
(1) providing an aqueous dispersion for spray-drying (S) by mixing at least
   an aqueous polymer dispersion comprising particles of a styrene-butadiene polymer (A), and
   a spray-drying aid which comprises at least one water-soluble polymer (B), selected from the group of phenol sulfonic acid-formaldehyde condensates, naphthalene sulfonic acid-formaldehyde condensates, melamine-formaldehyde condensates, formaldehyde-acetone-sulfite condensates, and copolymers comprising at least ethylenically unsaturated monomers comprising sulfonic acid groups and ethylenically unsaturated monomers comprising carboxylic acid groups, and
(2) spray-drying the resultant aqueous dispersion (S),
wherein at least one non-ionic emulsifier (C) is added to the aqueous dispersion for spray-drying (S), and/or mixed with the spray-dried product after spray drying.

In further embodiments, the invention relates to the use of a water-dispersible polymer powder composition (P) as mentioned above for cementing in subterranean formations penetrated by at least a well bore, dry cement formulations comprising at least cement and the water-dispersible polymer powder composition (P) as mentioned above, and the use of such a dry cement formulation for cementing in subterranean formations penetrated by at least a well bore.

In yet another embodiment, the present invention relates to the use of a water-dispersible polymer powder composition (P1) for cementing in subterranean formations penetrated by at least a well bore, comprising a step of adding at least one non-ionic emulsifier (C) to an aqueous cement slurry.

With regard to the invention, the following can be stated specifically:

### Water-Dispersible Polymer Powder Composition (P)

The water-dispersible polymer powder composition (P) according to the present invention comprises at least particles of a styrene-butadiene polymer (A), a water-soluble polymer (B), and a non-ionic emulsifier (C). It is suitable for use as additive in cementing in subterranean formations, in particular as anti-fluid-loss additive for cementing wellbores. The composition may be made by spray-drying an aqueous polymer dispersion (S) comprising at least particles of a styrene-butadiene polymer (A) and a spray-drying aid which comprises at least one water-soluble polymer (B).

The non-ionic emulsifier (C) may be added to the aqueous polymer dispersion (S) before spray-drying or added to the spray-dried product after spray-drying. It significantly improves the performance of the water-dispersible polymer powder composition (P) as compared to a composition in which a non-ionic emulsifier (C) is not present. It reduces the fluid loss, and it ensures a “rectangular” setting behavior of the cement slurry, i.e. the gel strength of the cement slurry remains low for a long time, so that the slurry remains pumpable and thereafter increases very rapidly.

The term “water-dispersible” means that the water-dispersible polymer powder composition (P) can be dispersed in water, thereby forming a dispersion of particles of a styrene-butadiene polymer in an aqueous phase.

### Particles of a Styrene-Butadiene Polymer (A)

The water-dispersible polymer powder composition (P) comprises particles of a styrene-butadiene polymer (A). Examples include styrene-butadiene copolymers (SB), styrene-butadiene rubbers (SBR), carboxyl-containing styrene-butadiene copolymers (XSB), carboxyl-containing styrene-butadiene rubbers (XSBR) and mixtures thereof.

Therefore, the copolymers contained in the polymer particles (A) comprise polymerized repeating units of styrene and/or a styrene derivative and polymerized repeating units of butadiene. In such polymers, typically the polymerized butadiene is 1,2-linked and/or 1,4-linked and the copolymers still have ethylenically unsaturated bonds. Preference is given to butadiene-styrene copolymers, wherein the weight ratio of styrene to butadiene is in the range from 10:90 to 90:10, in particular from 20:80 to 80:20, especially from 25:75 to 75:25. Usually, in these copolymers the total amount of polymerized styrene and butadiene is at least 80% by weight, based on the total amount of monomers forming the styrene-butadiene copolymer. Besides styrene and butadiene, the styrene-butadiene copolymer may contain other monomers. Examples comprise acrylonitrile, acrylic acid, methacrylic acid, acrylamide, itaconic acid, itaconic anhydride, maleic acid, or maleic acid anhydride. The amount of these other monomers will usually not exceed 20% by weight, in particular is 15% by weight or less, or 10% by weight or less, based on the total amount of monomers forming the styrene-butadiene copolymer. In one embodiment, the styrene-butadiene polymer comprises acrylonitrile, in particular up to 10 wt.-% of acrylonitrile.

The average particle size may be in the range of less than 1 μm, for example from 100 to 300 nm, measured by dynamic light scattering (DLS). The numbers refer to the D50 particle size. The particle size distribution can be achieved using ISO 22412:2008.

The glass transition temperature of the styrene-butadiene polymer may be selected by the skilled artisan according to his/her needs. In one embodiment it may be in the range from −10° C. to +30° C. (DSC, midpoint temperature, ASTM D 3418-82).

The amount of particles of a styrene-butadiene polymer (A) is from 50 to 98.5 wt.-%, relating to the total of all components of the composition (P), preferably from 60 wt.-% to 96 wt.-%, more preferably from 70 wt.-% to 90 wt.-%, and for example from 80 to 85 wt.-%.

### Water-Soluble Polymer (B)

The water-soluble polymer (B) is selected from the group of phenol sulfonic acid-formaldehyde condensates, naphthalene sulfonic acid-formaldehyde condensates, melamine-formaldehyde condensates, formaldehyde-acetone-sulfite condensates, and copolymers comprising at least ethylenically unsaturated monomers comprising sulfonic acid groups and ethylenically unsaturated monomers comprising carboxylic acid groups.

Phenol sulfonic acid-formaldehyde condensates are known in the art. Such polymers and their manufacture are described for example in WO 98/03576 A1. They may be prepared by condensation of phenol sulfonic acid with formaldehyde by means of acid catalysts, preferably sulfur containing acids such as sulfuric acid. Phenol sulfonic acid may be used as such, or alternatively, phenol sulfonic acid may be made in-situ by sulfonation of phenol with sulfuric acid. The molar proportion formaldehyde/phenol sulfonic acid typically is in the range from 1:1 to 1:2, preferably from 1:1.3 to 1.7. The condensation may be carried out at temperatures from 90° C. to 110° C. for 2 to 6 h. Acid groups may be fully or partly neutralized after condensation. The molecular weight of the product may be adjusted by the condensation temperature and the condensation time. A number average molecular weight of ≤1500 g/mole is advantageous, however, also products having a higher molecular weight may be used.

Naphthalene sulfonic acid-formaldehyde condensates are also known in the art. Such polymers and their manufacture are described for example in WO 98/03577 A1. They may be prepared in the same manner as the phenol sulfonic acid-formaldehyde condensates, except that naphthalene sulfonic acid or naphthalene are used instead of phenol sulfonic acid or phenol.

Melamine-formaldehyde condensates are known in the art. Such polymers and their manufacture are described for example in DE 3344291 A1. They may be prepared by condensation of melamine with formaldehyde and an acid introducing component. The molar proportion melamine/formaldehyde and sulfonic acid introducing component typically is in the range from 1:1 to 18:0,25 to 3,0. The condensation may be carried out at temperatures from 60° C. to 85° C. for 2 to 6 h. Acid groups may be fully or partly neutralized after condensation. The molecular weight of the product may be adjusted by the condensation temperature and the condensation time. A number average molecular weight of ≤1500 g/mole is advantageous, however, also products having a higher molecular weight may be used.

Formaldehyde-acetone-sulfite condensates are known in the art. Such polymers and their manufacture are described for example in DE 3344291 A1. They may be prepared by condensation of acetone with formaldehyde and an acid introducing component. The molar proportion acetone/formaldehyde and sulfonic acid introducing component typically is in the range from 1:1 to 18:0,25 to 3,0. The condensation may be carried out at temperatures from 60° C. to 85° C. for 2 to 6 h. Acid groups may be fully or partly neutralized after condensation. The molecular weight of the product may be adjusted by the condensation temperature and the condensation time. A number average molecular weight of ≤1500 g/mole is advantageous, however, also products having a higher molecular weight may be used.

Copolymers comprising at least ethylenically unsaturated monomers comprising sulfonic acid groups or salts thereof and ethylenically unsaturated monomers comprising carboxylic acid groups or salts thereof are known in the art. Such polymers and their manufacture are described for example in US 2020/0207671 A1 (polyacid II). Examples of ethylenically unsaturated monomers comprising sulfonic acid groups comprise vinylsulfonic acid, 2-hydroxy-3-rop-2-enoyloxy)propane-1-sulfonic acid, 2-hydroxy-3-[(meth)acryloyloxy]propane-1-sulfonic acid, 3-allyloxy-2-hydroxypropane-1-sulfonic acid, styrene-3-sulfonic acid, 3-(meth)allyloxybenzene-1-sulfonic acid, α-methylstyrenesulfonic acid, α-ethylstyrenesulfonic acid, allyloxybenzenesulfonic acid, (meth)allyloxybenzenesulfonicacid, bis(3-sulfopropyl) maleate, bis(2-sulfoethyl) maleate, bis(3-sulfopropyl) itaconate, bis(2-sulfoethyl) itaconate, 2-propene-1-sulfonic acid, 2-methyl-2-propene-1-sulfonic acid, 4-vinylphenylsulfonic acid and salts thereof. Of course, mixtures of the monomers can be used. In one embodiment of the invention, 2-methyl-2-propene-1-sulfonic acid or salts thereof are used. Examples of ethylenically unsaturated monomers comprising carboxylic acid groups or salts thereof comprise acrylic acid, methacrylic acid, maleic acid, and itaconic acid or salts thereof, preferably (meth)acrylic acid. In one embodiment of the invention, the copolymer comprises at least (meth)acrylic acid or salts thereof, preferably from 20 to 80 wt.-%, and 2-methyl-2-propene-1-sulfonic acid or salts thereof, preferably from 20 to 80 wt.-%, wherein the amounts relate to the total of all monomers in the copolymer. They may be prepared by radically polymerizing an aqueous solution of the monomers. In one embodiment of the invention, copolymers having a weight average molecular weight M_{w}<20000 g/mole, preferably <10000 g/mole may be used however, also products having a higher molecular weight may be used.

Of course, the water-dispersible polymer powder composition (P) may also comprise two or more different water-soluble polymers (B), selected from the group above.

The amount of water-soluble polymers (B) is from 1 to 20 wt.-%, relating to the total of all components of the composition (P), preferably from 2 wt.-% to 15 wt.-%, more preferably from 3 wt.-% to 12 wt.-%, and for example from 4 to 8 wt.-%.

In one embodiment of the invention, the water-soluble polymer (B) comprises at least a phenol sulfonic acid—formaldehyde condensate.

### Non-Ionic Emulsifier (C)

Basically, the non-ionic emulsifier (C) may be any kind of non-ionic emulsifier. Examples comprise linear or branched alkyl polyalkoxylates, for example fatty alcohol alkoxylates, fatty amin alkoxylates, fatty acid alkoxylates, alkyl polyglucosides or blockcopolymers, such as for example blockcopolymers of ethylene oxide and higher alkylene oxides.

In one embodiment of the invention, the non-ionic emulsifier (C) has the general formula

R¹—O—(CH₂—CHR²O)ₙH (I).

In formula (I), R¹ is a linear or branched aliphatic hydrocarbon moiety comprising 12 to 20 carbon atoms.

The moieties R² are selected independently from each other from the group of H, methyl and ethyl, wherein at least 50% of all R² groups are H. Preferably, at least 70% of all groups R² are H, more preferably at least 90%. In one embodiment R² is H, i.e. the polyalkoxy group comprises only ethoxy groups.

In formula (I), n is a number from 15 to 50 or from 15 to 40.

In one embodiment of the invention, R¹ is a linear aliphatic hydrocarbon moiety comprising 14 to 20, preferably 16 to 18 carbon atoms, R² is H, and n is a number from 20 to 30.

In another embodiment of the invention, R¹ is a branched aliphatic hydrocarbon moiety comprising 12 to 16, preferably 12 to 14 carbon atoms, R² is H, and n is a number from 30 to 50.

The amount of non-ionic surfactants is from 0.5 to 10 wt.-%, relating to the total of all components of the composition (P), preferably from 1 wt.-% to 7 wt.-%, more preferably from 1 wt.-% to 5 wt.-%, and for example from 1 to 2 wt.-%.

In one embodiment of the invention, the weight proportion B/C of water-soluble polymers (B) to the non-ionic emulsifiers (C) may be from 1:1 to 8:1, for example from 1:1 to 4:1.

Furthermore, the weight proportion of (B+C)/A, i.e. the proportion of water-soluble polymers (B) and the non-ionic emulsifiers (C) together to the polymer particles (A) may be from 0.05:1 to 0.2 to 1, for example from 0.05:1 to 0.15:1 or from 0.07:1 to 0.12:1.

Besides the non-ionic emulsifiers (C), the water-dispersible polymer powder composition (P) may also comprise ionic surfactants. However, the amount of the ionic surfactants should preferably be limited. As a rule, the amount of ionic surfactants-if present at all-should not exceed 50% by wt. regarding the non-ionic emulsifiers (C), preferably not more than 30% by wt. and more preferably not more than 10% by wt . . . . In one embodiment of the invention, only non-ionic emulsifiers (C) are used.

### Further Components

The water-dispersible polymer powder composition (P) may comprise further components besides the components (A), (B) and optionally (C).

In one embodiment, the composition (P) comprises at least one anti-blocking agent (D). Anti-blocking agents serve for the purpose that the particles of the polymer powder composition (P) don't stick to each other, in particular during storage or already during spray-drying. Examples of anti-blocking agents comprise silica, such as for example hydrophobic silica, amorphous precipitated silica, limestone powder or talc, bentonite, quartz sand, quartz flour, kieselgur, silica, colloidal silica gel, microsilica, fumed silica, or precipitated silica which may optionally have been hydrophobized, clay, magnesium hydrosilicates, talc (magnesium silicate hydrate), calcium hydrosilicates, kaolin (aluminum silicate hydrate), mica, xonolite, calcium sulfate, magnesium sulfate, barium sulfate, titanium dioxide, calcium carbonate, magnesium carbonate, or Ca/Mg carbonates. Of course, also a mixture of two or more different anti-blocking agents (D) may be used. In one embodiment of the invention, the composition (P) comprises a combination of hydrophobic silica with another anti-blocking agent, such as for example precipitated amorphous silica, limestone powder or talc.

In one embodiment of the invention, the amount of anti-blocking agents (D) is up to 30 wt.-%, relating to the total of all components of the composition (P), in particular from 0.5 to 30 wt.-%, preferably from 1 wt.-% to 20 wt.-%, more preferably from 5 wt.-% to 15 wt.-%, and for example from 8 to 12 wt.-%.

Examples of further components besides (A), (B), (C), and (D) comprise defoamers, thickeners, or retarders or accelerators for cement.

In the water-dispersible polymer powder composition (P) the styrene-butadiene polymer particles are at least partly covered by and/or embedded in a composition (X) comprising at least the water-soluble polymer (B).

So, the water-dispersible polymer powder composition (P) may comprise single polymer particles (A) which are covered by a composition (X) and/or particles which comprise a plurality of polymer particles (A) which are embedded in a composition (X).

In one embodiment of the invention, the composition (X) consists only of one or more water-soluble polymers (B). In another embodiment, the composition (X) comprises at least one or more water-soluble polymers (B) and one or more than one non-ionic emulsifiers (C).

### Embodiments of the Water-Dispersible Polymer Powder Composition (P)

In one embodiment, the composition (X) of the water-dispersible polymer powder composition (P) comprises at least one non-ionic emulsifier (C).

In one embodiment, the water-dispersible polymer powder composition (P) is a mixture of the non-ionic emulsifier(s) (C) and styrene-butadiene polymer particles (A) which are at least partly covered by and/or embedded in a composition (X).

In one embodiment, the water-soluble polymers (B) comprise at least phenol sulfonic acid-formaldehyde condensates.

In one embodiment of the water-dispersible polymer powder composition (P), the water-soluble polymers (B) comprise at least phenol sulfonic acid-formaldehyde condensates and a non-ionic surfactant having the general formula R¹—O—(CH₂—CHR²O)ₙH(I), wherein R¹ is a linear or branched aliphatic hydrocarbon moiety comprising 12 to 20 carbon atoms, R² is selected from the group of H, methyl and ethyl, wherein at least 50% of all R² groups are H, and n is from 15 to 50. Preferably, R¹ is a linear aliphatic hydrocarbon moiety comprising 14 to 20, preferably 16 to 18 carbon atoms, R² is H, and n is a number from 20 to 30.

In one embodiment, the water-dispersible polymer powder composition (P) comprises
60 to 96 wt.-% of the particles of the styrene-butadiene polymer (A),
1 to 15 wt.-% of at the water-soluble polymer(s) (B), preferably phenol sulfonic acid-formaldehyde condensates,
1 to 7 wt.-% of non-ionic emulsifier(s) (C), preferably of the general formula R¹—O—(CH₂—CHR²O)ₙH(I), wherein R¹ is a linear or branched aliphatic hydrocarbon moiety comprising 12 to 20 carbon atoms, R² is selected from the group of H, methyl and ethyl, wherein at least 50% of all R² groups are H, and n is from 15 to 50, and
1 to 20 wt. % of anti-blocking agent(s) (D),
wherein the amounts relate to the total of all components of the composition (P).

In one embodiment, the water-dispersible polymer powder composition (P) comprises
70 to 90 wt.-% of the particles of the styrene-butadiene polymer (A),
3 to 12 wt.-% of at the water-soluble polymer(s) (B), comprising at least a phenol sulfonic acid-formaldehyde condensate,
1 to 5 wt.-% of non-ionic emulsifier(s) (C), having the formula R¹—O—(CH₂—CHR²O)ₙH, wherein R¹ is a linear or branched aliphatic hydrocarbon moiety comprising 12 to 20 carbon atoms, R² is selected from the group of H, methyl and ethyl, wherein at least 50% of all R² groups are H, and n is from 15 to 50, and
5 to 15 wt. % of anti-blocking agent(s) (D),
wherein the amounts relate to the total of all components of the composition (P).

### Process for Making a Water-Dispersible Polymer Powder Composition (P)

The process making a water-dispersible polymer powder composition (P) comprises at least two steps (1) and (2).

### Step (1)

In course of step (1), an aqueous dispersion for spray-drying (S) is prepared. The aqueous dispersion for spray-drying (S) comprises at least an aqueous polymer dispersion comprising particles of a styrene-butadiene polymer (A), and a spray-drying aid which comprises at least one water-soluble polymer (B).

Aqueous dispersions of butadiene-styrene polymers and their manufacture are known in the art. Details about the butadiene-styrene-polymers have already been disclosed and we refer to the respective passages above.

The contents of styrene-butadiene polymer in the aqueous dispersion may be from 40 wt.-% to 60 wt.-%.

The spray-drying aid comprises at least one water-soluble polymer (B), selected from the group of phenol sulfonic acid-formaldehyde condensates, naphthalene sulfonic acid-formaldehyde condensates, melamine-formaldehyde condensates, formaldehyde-acetone-sulfite condensates, and copolymers comprising at least ethylenically unsaturated monomers comprising sulfonic acid groups and ethylenically unsaturated monomers comprising carboxylic acid groups. Details about the water-soluble polymer (B) have already been disclosed and we refer to the respective passages above.

Of course, a mixture of two or more water-soluble polymers (B) may be used.

The water-soluble polymers (B) are usually used as aqueous solutions, for example aqueous solutions comprising from 25 to 50 wt.-% of polymers (B), relating to the total of all components of the aqueous solution.

In one embodiment of the invention, they spray-drying aid comprises at least a phenol sulfonic acid-formaldehyde condensate, more preferably, the spray-drying agent is a phenol sulfonic acid-formaldehyde condensate.

In one preferred embodiment of the invention, the aqueous dispersion for spray-drying (S) furthermore comprises at least one non-ionic emulsifier (C). Details about the non-ionic emulsifiers (C) have already been disclosed and we refer to the respective passages above.

The aqueous dispersion for spray-drying (S) is prepared by mixing the components (A), (B), and optionally (C) with each other. The water-soluble polymers (B) and the emulsifiers (C) should preferably be added to the aqueous dispersion comprising (A) as aqueous solution. Water may be added to adjust the concentration. Mixing may be carried out by common technologies, for example by stirring.

Preferred compositions of the water-dispersible polymer powder compositions (P) and the amounts of the components (A), (B), and (C) in the water-dispersible polymer powder composition (P), including preferred embodiments have already been disclosed above.

The kinds and amounts of the components (A), (B), and optionally (C) in the aqueous dispersion for spray-drying (S) are adjusted accordingly.

The concentration of the components (A), (B), optionally (C) and further components in the aqueous dispersion for spray-drying (S) may be in the range from 30 wt.-% to 70 wt.-%, preferably from 40 wt.-% to 60 wt.-%, relating to the total of all components of the aqueous dispersion for spray-drying (S).

### Step (2)

In course of step (2), the aqueous dispersion for spray-drying (S) obtained in course of step (1) is spray-dried.

Suitable devices for spray-drying are commercially available. Any kind of drying gas may be used, provided, for example air, air having a depleted oxygen contents, nitrogen, argon or mixtures thereof. In one embodiment, nitrogen is used as drying gas. The aqueous dispersion for spay-drying (S) to be dried may be sprayed into the spray dryer be means of a one-fluid nozzle, a two-fluid nozzle or a rotary disk. The inlet temperature of the dryer gas may be from 100° C. to 200° C., preferably from 120° C. to 160° C., and for example from 130° C. to 140° C.; its outlet temperature may be from 30° C. to 90° C., for example from 60° C. to 70° C. The spray-dried product may be separated by means of cyclones or filters.

An anti-blocking agent (D) may optionally fed into the drying chamber, for example at the top of the dryer, into the cone of the dryer, into the drying gas, or, less preferred, within the spray-feed. Its aim is avoiding that particles stick to the walls of the drying chamber and avoiding agglomeration. In one embodiment, the anti-blocking agent is fed through an additional nozzle. Such an anti-blocking agent may be for example hydrophobic silica powder. Further examples have already been mentioned above. The amount of such an anti-blocking agent may be adjusted by the skilled artisan according to his/her needs. In embodiments of the invention, up to 2 wt.-% of such an anti-blocking agent may be used, relating to the total of all components of the water-dispersible polymer powder composition (P), for example from 0.25 to 1.5 wt.-%.

The spray-drying step (2) yields water-dispersible polymer powder compositions (P) which are essentially free of water and which should be free-flowing. However, the term “polymer powder” does not rule out, that the final product comprises small amounts of residual water, e.g. water in an amount of less than 2 wt.-%, relating to the total of all components of the water-dispersible polymer powder compositions (P).

After spray-drying the obtained product may optionally be mixed with an anti-blocking agent (D) in order to avoid agglomeration of the particles in course of storage and transport. Examples of anti-blocking agents (D) and their amounts have already been mentioned above and we refer to the respective passages. Of course, a first anti-blocking agent may be added during spray-drying as outlined above and a second anti-blocking agent, which may be the same or different, may be added after spray-drying.

In one embodiment of the invention, the non-ionic emulsifier (C) is added to the aqueous dispersion for spray-drying (S). In this embodiment, the non-ionic emulsifier (C) or at least a part thereof may become a component of the composition (X) as outlined above.

In another embodiment of the invention, the non-ionic emulsifier (C) is mixed with the spray-dried product after spray drying, i.e. the resultant water-dispersible polymer powder composition (P) is a mixture of the non-ionic emulsifier(s) (C) and styrene-butadiene polymer particles (A) which are at least partly covered by and/or embedded in a composition (X).

### Use of the Water-Dispersible Polymer Powder Composition (P)

In a further embodiment, the present invention relates to the use of the water-dispersible polymer powder composition (P) as described above for cementing in subterranean formations penetrated by at least a well bore comprising at least the following steps:
(a) preparing an aqueous cement slurry by mixing at least a hydraulic cement, a water-dispersible polymer powder composition (P) as described above, and sufficient water to form a pumpable slurry;
(b) placing said aqueous cement slurry through a well bore to a zone to be cemented, and
(c) allowing said aqueous cement slurry to set.

Hydraulic cements set and harden by reaction with water. Examples of hydraulic cements comprise Portland cements, pozzolana cements, gypsum cements, high alumina content cements, silica cements and high alkalinity cements. Preferably, Portland cements may be used, in particular Portland cements of the types defined and described in API Specification for Materials And Testing For Well Cements, API Specification 10, 5th Edition, dated Jul. 1, 1990 of the American Petroleum Institute. API Portland cements including classes A, B, C, G and H can be utilized, preferably Portland cements of the classes G and H, for example G.

In course of step (a), an aqueous cement slurry is prepared by mixing at least a hydraulic cement, the water-dispersible polymer powder composition (P) as described above, and sufficient water to form a pumpable slurry.

The water utilized in the aqueous cement slurry may be fresh water, unsaturated salt water and saturated salt water including brines or seawater. The water is present in the aqueous cement slurry in an amount sufficient to form a pumpable slurry.

In course of step (a), the hydraulic cement, the water and the water-dispersible polymer powder composition (P) as described above are mixed with each other. Techniques for mixing cement slurries are known to the skilled artisan.

The amount of water-dispersible polymer powder composition (P) to be used for the cement may be selected by the skilled artisan. The higher the amount of the composition (B), the better the effect as anti-fluid-loss additive. In one embodiment of the invention, the amount of the water-dispersible polymer powder composition (P) is from 2 to 30 wt.-%, preferably from 8 to 15 wt.-%, relating to the cement.

The cement slurries may of course comprise further components. Examples of such further components are basically known in the art and include weighting materials, set retarding additives, set accelerators, strength stabilizers, strength enhancers, lightweight additives, anti-gas migration additives, defoamers, foamers, silica flour or expansion additives.

In course of step (b), the aqueous cement slurry prepared in course of step (a) is placed through a well bore to the zone to be cemented. In particular, the aqueous cement slurry is placed into the annulus between the casing and the wellbore wall.

In course of a usual cementing operation for wellbores, the aqueous cement slurry is pressed through the casing to the bottom of the wellbore where it enters into the annulus between the casing and the wellbore wall where it streams back towards the surface, thereby filling the annulus completely. Of course, the cement slurry may be used for other operations, for example secondary cementing or plug cementing.

In course of step (c) the aqueous cement slurry is allowed to set.

### Dry Cement Composition

In a further embodiment, the present invention relates to a dry cement composition comprising at least
a hydraulic cement, and
a water-dispersible polymer powder composition (P) as described above.

Suitable hydraulic cements have already been mentioned above.

Water-dispersible polymer powder compositions (P) have also been described above. Of course, the dry cement composition may comprise two or more than two different water-dispersible polymer powder compositions (P).

Depending on the nature of the water-dispersible powder composition(s) (P) used, the non-ionic emulsifier(s) (C) may be part of the composition (X) embedding and/or covering the styrene-butadiene polymer particles (A) or it may be a separate component of the dry cement composition, or both.

The amount of water-dispersible polymer powder composition (P) in the dry cement formulation may be selected by the skilled artisan. In one embodiment of the invention, the amount water-dispersible polymer powder composition (P) is from 2 to 30 wt.-%, preferably from 8 to 15 wt.-%, relating to the cement.

Of course, the dry cement formulation may comprise further components. Examples of such further components are basically known in the art and include weighting materials, set retarding additives, set accelerators, strength stabilizers, strength enhancers, lightweight additives, anti-gas migration additives, defoamers, foamers, or expansion additives.

Such a dry cement formulation is made by mixing dry hydraulic cement and water-dispersible polymer powder composition (P) as described above.

### Use of the Dry Cement Composition

In a further embodiment, the present invention relates to the use of the dry cement composition as described above for cementing in subterranean formations penetrated by at least a well bore, comprising at least the following steps:
(a) preparing an aqueous cement slurry by mixing at least the dry cement composition, and sufficient water to form a pumpable slurry;
(b) placing said aqueous cement slurry through a well bore to a zone to be cemented, and
(c) allowing said aqueous cement slurry to set.

The use of the dry cement formulation for cementing in subterranean formations basically is carried out in the same manner as described above, except that cement and the water-dispersible polymer powder composition (P) are provided separately, but the pre-mixed dry cement formulation as described above is used. Further additives may be added separately, but preferably are already a component of the dry cement mixture.

So, step (a) comprises preparing an aqueous cement slurry by mixing at least the dry cement composition, and sufficient water to form a pumpable slurry. Steps (b) and (c) are carried out as described above.

### Use of a Water-Dispersible Polymer Powder Composition (P1)

In yet another embodiment, the present invention relates to the use of a water-dispersible polymer powder composition (P1) comprising at least
50 to 99 wt.-% of particles of a styrene-butadiene polymer (A),
1 to 20 wt.-% of at least one water-soluble polymer (B), selected from the group of phenol sulfonic acid-formaldehyde condensates, naphthalene sulfonic acid-formaldehyde condensates, melamine-formaldehyde condensates, formaldehyde-acetone-sulfite condensates, and copolymers comprising at least ethylenically unsaturated monomers comprising sulfonic acid groups and ethylenically unsaturated monomers comprising carboxylic acid groups,
up to 30 wt.-% of at least one anti-blocking agent (D), wherein the amounts relate to the total of all components of the composition (P1), and wherein the styrene-butadiene polymer particles are at least partly covered by and/or embedded in a composition (X) comprising at least the water-soluble polymer (B),

for cementing in subterranean formations penetrated by at least a well bore, comprising at least the following steps:
(a) preparing an aqueous cement slurry by mixing at least a hydraulic cement, the water-dispersible polymer powder composition (P1), and sufficient water to form a pumpable slurry;
(b) placing said aqueous cement slurry through a well bore to a zone to be cemented; and
(c) allowing said aqueous cement slurry to set,
wherein additionally 0.5 to 10 wt.-% of at least one non-ionic emulsifier (C), relating to the water-dispersible polymer powder composition (P1), are added to the aqueous cement slurry.

The water-dispersible polymer powder composition (P1) differs from the composition (P) in that no non-ionic emulsifiers (C) are present. A non-ionic emulsifier (C) is added not to the composition (C), but it is added later to the aqueous cement slurry. As will be shown in the experimental part, also adding the non-ionic emulsifier (C) later reduces the fluid loss as compared to a cement slurry without emulsifier (C). Furthermore, it also yields a “rectangular” setting behavior.

The components (A) and (B) including preferred embodiments have already been disclosed above.

The water-dispersible polymer powder composition (P1) may also comprise up to 30 wt.-% of at least one anti-blocking agent (D) as descried above, and it may also comprise further components as described above.

Because the non-ionic emulsifiers (C) are not present un the composition (P1), the amounts of (A) and (B) are a bit different.

The amount of particles of a styrene-butadiene polymer (A) is from 50 to 99 wt.-%, relating to the total of all components of the composition (P), preferably from 65 wt.-% to 97 wt.-%, more preferably from 73 wt.-% to 92 wt.-%, and for example from 80 to 88 wt.-%.

The amount of water-soluble polymers (B) is from 1 to 20 wt.-%, relating to the total of all components of the composition (P), preferably from 2 wt.-% to 15 wt.-%, more preferably from 3 wt.-% to 12 wt.-%, and for example from 4 to 8 wt.-%.

In one embodiment of the invention, the amount of anti-blocking agents (D) is up to 30 wt.-%, relating to the total of all components of the composition (P), in particular from 0.5 to 30 wt.-%, preferably from 1 wt.-% to 20 wt.-%, more preferably from 5 wt.-% to 15 wt.-%, and for example from 8 to 12 wt.-%.

The use of the water-dispersible polymer powder particle (P1) for cementing in subterranean formations penetrated by at least a well bore comprises at least the steps (a), (b), and (c). The steps are carried out as outlined above, except that the composition (P1) instead of the composition (P) is used, and the non-ionic emulsifier (C) is added separately to the aqueous cement slurry, preferably as aqueous solution, for example as aqueous solution having a concentration from 10 to 50 wt.-% of the emulsifier, relating to the total of the aqueous solution.

The amount of non-ionic surfactants is from 0.5 to 10 wt.-%, relating to the total of all components of the composition (P), preferably from 1 wt.-% to 7 wt.-%, more preferably from 1 wt.-% to 5 wt.-%, and for example from 1 to 2 wt.-%.

### Advantages of the Present Invention

The water-dispersible polymer powder compositions (P) according to the present invention comprising a non-ionic emulsifier (C) have significant advantages as compared to particles, in which the non-ionic emulsifier (C) is not present. Using them as additive for cementing in subterranean formations significantly reduces the fluid loss. Furthermore, a “rectangular” setting behavior of the cement slurry is obtained, i.e. the gel strength of the cement slurry remains low for a long time, so that the slurry remains pumpable and thereafter increases very rapidly.

### EXAMPLES

The invention is illustrated in detail by the examples which follow.

### Starting Materials

For the examples and comparative examples, the following starting materials were used:

### Aqueous Dispersions

### Dispersion No. 1:

### Commercially Available Styrene-Butadiene Latex (Styrofan® D 623)

Solids content: 51 wt. %, pH 7.8-10.0. The average particle size (D 50 value) of the polymer particles as measured by dynamic light scattering is 185 nm.

### Spray Drying Aids:

### Spray Drying Aid No. 1

### Phenol Sulfonic Acid-Formaldehyde Polycondensate (PSA-F)

A phenol sulfonic acid-formaldehyde condensation product with a molecular weight of M_{w}˜8000 g/mol was synthesized as described in WO 98/03576 A1 page 14, line 42 to page 15, line 12.

### Spray Drying Aid No. 2

### Naphthalene Sulfonic Acid-Formaldehyde Condensation Product (NSA-F)

A naphthalene sulfonic acid-formaldehyde condensation product with a molecular weight of M_{w}˜ 7000 g/mol was synthesized as described in WO 98/03577 A1, page 14, lines 17-33.

### Spray Drying Aid No. 3

### Formaldehyde-Acetone-Sulfite Polycondensate (F-A-S)

In a reaction vessel equipped with reflux condenser, stirrer, thermometer, dropping funnel, and nitrogen sparging, a solution of 287 g of water and 142.5 g sodium pyrosulfite (Na₂S₂O₅) was stirred. During the dropwise addition of 230 g of a 30% sodium hydroxide solution, the temperature was kept below 60° C. After the addition of 226 mL acetone, the mixture was heated to 60° C. and 783 mL of an aqueous formalin solution (30%) was added within one hour under stirring at 60° C. The reaction mixture was stirred at 60° C. for 10 min and 530 mL of the solvent were removed by applying a vacuum. The mixture was cooled down to 30° C., and then neutralized by adding an aqueous formic acid solution until a pH of 7.0 was reached. The resulting product was a polymer solution having a solids content of 33% by weight, and a molecular weight M_{w} of ˜17300 g/mol.

### Spray Drying Aid No. 4

### Formaldehyde-Melamine Polycondensate

In a reaction vessel equipped with reflux condenser, stirrer, thermometer, dropping funnel, and nitrogen sparging, a solution of 90.2 g of water and 292 g of an aqueous 30% formalin solution was stirred and tempered to 30° C. Afterwards, 0.1 g of a 20% sodium hydroxide solution was added until a pH of 9-10 was reached. While stirring, successively were added: 126 g melamine within 15 min, 23.6 g of a 20% sodium hydroxide solution within 10 min, and 121.3 g sodium pyrosulfite within 30 min. The cloudy suspension was tempered to 78° C. and stirred for 60 min Afterwards, at 77° C. while stirring, the addition of a 20% sodium hydroxide solution took place within 15 min until a pH of 5.7 resulted. After stirring for 30 min, 13.3 g of a 20% sodium hydroxide solution was added until a pH of 11.0 was reached. This pH value was kept constant for 1-3 h (if necessary, by post-dosing of the sodium hydroxide solution). The reaction mixture was cooled down to room temperature and neutralized to a pH of 7-8 by the addition of a 20% sulfuric acid solution. The resulting product was a yellowish polymer solution having a solids content of 46% by weight, and a molecular weight MW of ˜ 18600 g/mol.

### Spray Drying Aid No. 5

Copolymer of Na-2-methylprop-2-ene-1-sulfonate and methacrylic acid

In a reaction vessel equipped with reflux condenser, stirrer, thermometer, dropping funnel, and nitrogen sparging, an initial charge of 200 g of water, 81 g of Na-2-methylprop-2-ene-1-sulfonate, and 1.5 g of 2,2′-azobis(2-methylpropionamidine)dihydrochloride (Wako V50) were heated to 73° C. On attainment of the temperature, while stirring at 73-81° C., a solution of 1.5 g of 2,2′-azobis(2-methylpropionamidine)dihydrochloride, 250 g of meth acrylic acid, and 130 g of water were metered in over a period of 1 h. The reaction solution was stirred at 80° C. for 1 h and then cooled down to room temperature. The resulting product was a clear polymer solution having a solids content of 50.3% by weight, a pH of 1.4, and a molecular weight M_{w} of ˜1400 g/mol.

### Emulsifiers

| | | |
|---|---|---|
| Emulsifier No. 1 | C_{16/18}-(EO)₂₅H | Lutensol ® AT 25 |
| Emulsifier No. 2 | C_{16/18}-(EO)₁₈H | Lutensol ® AT 18 |
| Emulsifier No. 3 | Cᵢ₁₃(EO)₄₀H | Emulan ® TO 4070 |
| Emulsifier No. 4 | C_{16/18}-(EO)₃₀H | Disponil ® A 4065 |
| Emulsifier No. 5* | C_{10/16}-O(C₆H₁₀O₅)ₙH | Glucopon ® 600 CSUP |
| Emulsifier No. 6 | C₉H₁₉-tert-C₆H₄O- | Tergitol ® NP-30 |
| | (EO)₂₅H | |

*Emulsifier No. 5 belongs to the group of alkyl polyglycosides.

### Commercial Polymer Powders

### Powder No. 1

### Commercially Available Redispersible Polymer Powder on Basis of a Styrene-Butadiene Latex

Axilat® PSB 150 from Synthomer. The product is recommended for civil construction applications, inter alia for repair mortars, tile adhesives or gypsum. The glass transition temperature (T_{g}) is +15° C. and the products has minimum film forming temperature (MFFT) of 8° C.

### Powder No. 2

### Commercially Available Redispersible Powder on Basis of a Styrene-Acrylic Polymer

Acronal® S 735 P is available from BASF. The product is recommended for civil construction applications, inter alia for ceramic tile adhesives or repair mortars on basis of cement or gypsum. The glass transition temperature (T_{g}) is +20° C.

### Manufacture of the Polymer Powders

### 1^{st} Step: Preparation of the Dispersion to be Spray Dried

For making the dispersions to be spray dried the aqueous polymer dispersion chosen (aqueous dispersion No. 1 or No. 2 as described above) was mixed with an aqueous solution of the spray drying aid chosen (selected from spray drying aids No. 1 to No. 5 as described above) and an aqueous solution of the emulsifier chosen (selected from emulsifiers No. 1 to No. 6) while stirring. The amounts of spray drying aid and emulsifier used are shown in table 1. Additional water was used to adjust the concentration of the dispersion to be dried to 40 wt.-% to 60 wt.-% relating to the total of all actives in the spray feed.

### 2^{nd} Step: Spray Drying of the Dispersion

Spray drying was conducted by means of a commercially available, laboratory-scale spray dryer (Niro Atomizer from Gea) using nitrogen as drying gas. The aqueous dispersion to be dried was sprayed through a two-fluid nozzle or a rotary disk. The inlet temperature of the dryer gas was 130 to 140° C.; its outlet temperature was 60 to 70° C. A first anti-blocking agent (1% by weight of hydrophobic silica powder, based on the based on the total of all components of the final product) was fed into the drying chamber through an additional nozzle.

After removing the obtained powder from the spray dryer it was mixed with about 9% by weight (based on the based on the total of all components of the final product) of a second anti-blocking agent, which were selected from commercially available anti-blocking agents, namely talc (from Imerys, Luzenac, France), limestone powder (Omyalite® 90), or amorphous precipitated silica (Sipernat® D120).

### Application Tests

### Test Methods

In the examples of this patent application, cement slurry rheology, gel strength, thickening time and fluid loss are measured according to American Petroleum Institute Recommended Practices (API RP 10B-2—Recommended Practice for Testing Well Cements) and transition time is measured according to API RP 10B-6 (Second Edition, April 2013). In the following, the methods used are briefly summarized:

### Cement Slurry Rheology Measurement

The rheology of the freshly mixed cement slurry was determined directly after mixing the components for the cement slurry according to the method described in the following.

### a) Rheology Measured at Different Shear Stress

For cement slurry rheology measurement, a rotational rheometer of the couette type was used (Fann Model 35A). Immediately after mixing the cement slurry was poured into viscometer cup to the fill line. The cup was raised until the liquid level reached the inscribed line on the sleeve. The rheology was measured at different rotational speeds. The measurement started at a rotational speed of 3 rpm and thereafter was increased stepwise to 6 rpm, 100 rpm, 200 rpm, 300 rpm, and 600 rpm. For each step of increasing the rotational speed, it was waited until a constant value was reached, which typically took about 10 s.

### b) Static Gel Strength

Static gel strength was measured immediately after determining the rheological properties of the slurry with the same couette type rheometer. The slurry has been left undisturbed for 10 see and then the static gel strength was measured at 3 rpm. After the slurry was allowed to rest for 10 min, the static gel strength was again measured at 3 rpm.

Both, the static gel strength and the rheology are expressed as lb/100 ft². 1 lb/100 ft² corresponds to 0.479 Pa.

### Thickening Behavior:

Two different methods were used to determine the thickening behavior of the cement slurry as a function of time.

### a) Measurement of the Static Gel Strength as a Function of Time by Ultrasonic Sound

For the measurement of the static gel strength as a function of time a Chandler Static Gel Strength Analyzer, Model 5265 was used. The instrument is an ultrasonic cement analyzer and the instrument determines how the cement's properties are inferred by measuring the change in the energy level of an ultrasonic signal transmitted through the cement specimen as it cures. It allows the evaluation of the gel strength development under downhole conditions, i.e. temperature and pressure of the cement can be adjusted accordingly.

### b) Measurement of the Consistency as a Function of Time

The tests were performed by means of a Chandler Model 8340 Consistometer. Thickening time tests are designed to determine the period of time a cement slurry remains pumpable under simulated wellbore conditions. The test slurry is evaluated in a pressurized consistometer which measures the consistency of the test slurry contained in rotating cup. The consistency of the slurry is measured in Bearden units (Bc), a dimensionless quantity with no direct conversion factor to more common units of viscosity. The end of the thickening time test occurs when the cement slurry reaches a consistency of 70 Bc, which is the maximum pumpable consistency.

### Fluid Loss Control:

Fluid loss tests measure the slurry dehydration during a cement job. The test slurry is placed in a heated cell and subjected to 68.95*10⁵ Pa (1000 psi) of differential pressure by means of nitrogen. The filtrate loss is measured across a standard filtration medium of 45 μm mesh size (325 mesh) supported on a 250 μm (60 mesh) screen. After 30 min the collected filtrate volume is noted. The reported fluid loss value is equal to the collected filtrate volume multiplied by two.

For tests that “blow out” (i.e. nitrogen blows through the sample) in less than the 30 min test interval, the fluid loss is calculated according to the following formula: Calculated Fluid Loss=2 Qₜ*5.477/\sqrt{t}. Qₜ is the volume (ml) of the filtrate collected at the time t (min) when nitrogen blows through.

### Evaluation of Colloidal Stability of the Polymer Powder

The test aims at determining whether the dry polymer powders are re-dispersible in an aqueous medium and whether the polymer dispersions obtained are stable.

10 ml of the cement slurry prepared according to API RP 10-B are added into a graduated cylinder. The cylinder is then filled with 90 ml of water up to 100 ml volume. This diluted cement slurry is stirred for approx. 20 sec with a spatula. The slurry was allowed to rest for 1 hour and thereafter the latex stability was assessed by visual inspection. According to the criteria mentioned in the following, the latex stability was rated as “good”, “bad” and “no”.
“Good”: Redispersible and stable;
The cylinder contains a grey sediment consisting of cement and of inorganic anti-blocking agents. The liquid above the sediment is homogenous milky. It can be colored due to water soluble spray drying aids. No flocks of organic material are visible.
“medium”: Redispersible but not stable:
The cylinder contains a grey sediment consisting of cement and of inorganic anti-blocking agents. The liquid above the sediment shows a multiphase separation with a clear water phase and a flocculated organic polymer phase.
“No”: Dry polymer powder not dispersed:
The cylinder contains a grey sediment consisting of cement and of inorganic anti-blocking agents, as well as of the latex powder. The liquid above the sediment is clear. Depending on the density and hydrophobicity of the latex powder, it can float or settle on the sediment.

### Preparation of Cement Slurries—General Description of the Procedure:

For the tests Class G cement according to API standards was used. The specific composition of the cement slurries is described below.

The required amount of water is added in a propeller type mixer (Warring Blender Model 24CB 10C). All dry materials are uniformly blended with the cement before addition to the water. The mixer is operated at 4000 rpm for 15 sec, during which all of the solids should be added to the mix water. Then the mixing speed is raised to 12 000 rpm for 35 sec. For monitoring the strengthening behavior, the time measurement starts (i.e. t=0) immediately after mixing the components.

### Results of the Tests

### Test Series 1

Several powder polymer samples were prepared by mixing polymer latices with spray drying aids, surfactants and water, followed by spray drying the obtained mixtures thereby obtaining dry powder polymer samples (powders 1 to 15 and comparative powder C2). One polymer sample was prepared in the same manner but without adding the surfactant (comparative example C1). Furthermore, two commercially available polymer powders were used for the tests (comparative examples C3 and C4).

All the dry polymer powders were used for making cement slurries. For making the cement slurry, the following components were used:

| | | |
|---|---|---|
| 720 | g | Dyckerhoff Class G cement |
| 317 | g | deionized water |
| 3 | g | commercially available silicone defoamer |
| | | (FoamStar ® SI 2201) |
| 64 | g | dry polymer powder as described above |

The components were mixed as described above and the resultant cement slurries were tested regarding their rheology, their static gel strength and their colloidal stability. The results are summarized in table 1.

TABLE 1
Evaluation of colloidal stability and cement slurry rheology at room temperature

| | | Samples prepared | | | | | |
|---|---|---|---|---|---|---|---|
| | | polymer | | | | | |
| | Commercial | particles | | Spray drying aid | | Emulsifier | |
| | samples | | amount | | amount | | amount |
| No. | No./type | No./type | [wt. %]¹ | No./type | [wt. %]² | No./type | [wt. %]³ |
| C1 | — | 1/SB | 84.1 | 1/PSA-F | 5.9 | — | — |
| 1 | — | 1/SB | 82.6 | 1/PSA-F | 5.8 | 1/C_{16/18}-(EO)₂₅H | 1.6 |
| 2 | — | 1/SB | 84.1 | 1/PSA-F | 4.2 | 1/C_{16/18}-(EO)₂₅H | 1.7 |
| 3 | — | 1/SB | 81.1 | 1/PSA-F | 5.7 | 1/C_{16/18}-(EO)₂₅H | 3.2 |
| 4 | — | 1/SB | 83.3 | 1/PSA-F | 5.8 | 1/C_{16/18}-(EO)₂₅H | 0.8 |
| 5 | — | 1/SB | 84.1 | 1/PSA-F | 5.8 | 2/C_{16/18}-(EO)₁₈H | 1.6 |
| 6 | — | 1/SB | 84.1 | 1/PSA-F | 5.8 | 3/Cᵢ₁₃(EO)₄₀H | 1.6 |
| 7 | — | 1/SB | 84.1 | 1/PSA-F | 5.8 | 4/C_{16/18}-(EO)₃₀H | 1.6 |
| 8 | — | 1/SB | 84.1 | 2/NSA-F | 5.8 | 1/C_{16/18}-(EO)₂₅H | 1.6 |
| 9 | — | 1/SB | 84.1 | 3/F-A-S | 5.8 | 1/C_{16/18}-(EO)₂₅H | 1.6 |
| 10 | — | 1/SB | 80.4 | 4/MF | 8.0 | 1/C_{16/18}-(EO)₂₅H | 1.6 |
| 11 | — | 1/SB | 84.1 | 5/AP | 5.8 | 1/C_{16/18}-(EO)₂₅H | 1.6 |
| 12 | — | 1/SB | 76.9 | 5/AP | 11.6 | 1/C_{16/18}-(EO)₂₅H | 1.5 |
| 13 | — | 1/SB | 84.1 | 1/PSA-F | 5.8 | 1/C_{16/18}-(EO)₂₅H | 1.6 |
| 14 | — | 1/SB | 84.1 | 1/PSA-F | 5.8 | 5/C_{10/16}-O(C₆H₁₀O₅)ₙH | 1.6 |
| 15 | — | 1/SB | 84.1 | 1/PSA-F | 5.8 | 6/C₉H₁₉-tert-C₆H₄O- | 1.6 |
| | | | | | | (EO)₂₅H | |
| C2 | 1/SB | — | | — | — | — | — |
| C3 | 2/SA | — | | — | — | — | — |

| | | Application test | | |
|---|---|---|---|---|
| | Samples prepared | | Rheology at RT | Static gel |
| | anti- | | [lb/100 ft²] | strenght at RT |
| | blocking | Colloidal | (600-300-200-100-6- | [lb/100 ft²] |
| No. | agent⁴ | stability | 3 rpm) | (10 s/10 min) |
| C1 | silica | medium | 104-51-33-17-1-0 | 1/1 |
| 1 | silica | good | 134-70-47-24-2-1 | 2/18 |
| 2 | silica | good | 153-83-57-30-2-1 | 3/39 |
| 3 | silica | good | 143-74-50-25-2-1 | 3/17 |
| 4 | silica | good | 117-59-40-20-1-1 | 1/7 |
| 5 | silica | good | 132-67-44-22-1-1 | 0/2 |
| 6 | silica | good | 147-80-56-30-4-3 | 4/26 |
| 7 | silica | good | 154-80-56-30-4-3 | 3/29 |
| 8 | silica | medium | 119-60-39-20-1-1 | 2/16 |
| 9 | silica | medium | 163-78-50-24-1-1 | 1/12 |
| 10 | silica | good | 191-99-65-31-1-1 | 1/22 |
| 11 | silica | good* | 112-57-39-30-2-1 | 1/3 |
| 12 | silica | good | 186-102-72-40-4-3 | 4/18 |
| 13 | talc | good | 115-59-40-21-2-1 | 2/10 |
| 14 | silica | good | 57-29-19-10-1-0 | 1/1 |
| 15 | silica | good | 76-45-32-18-2-1 | 2/49 |
| C2 | — | no | 81-50-37-24-11-11 | 22/161 |
| C3 | — | no | 79-39-26-13-1-0 | 1/18 |

Abbreviations:
SB: styrene-butadiene latex,
SA: Styrene-acrylate latex;
PSA-F: Phenol sulfonic acid-formaldehyde condensate,
NSA-F: naphthalene sulfonic acid-formaldehyde condensate,
MF: melamine-formaldehyde condensate;
AP: anionic copolymer,
F-A-S: formaldehyde-acetone-sulfite condensation product
^{1,2,3}amounts relate to the total of all components,
*strong retardation
⁴All samples comprise a total of 10 wt. % of anti-blocking agents, 1 wt.-% of hydrophobic silica and 9 wt.-% of amorphous precipitated silica (Sipernat ® D120) or talc (as indicated in table 1′.

The rheology and the static gel strength were measured immediately after mixing the components of the cement slurry, i.e. the values refer not to any hardening processes but to the unhardened cement slurry.

For oilwell cementing a low cement slurry viscosity during pumping is necessary, so that the cement slurry can be easily pumped and properly placed into the annulus between the casing and the wall of the wellbore. The measurement of the static gel strength refers to the situation that the pumping the cement slurry is interrupted, and the cement slurry rests for a while without shearing. The static gel strength should not increase too much during the time period the slurry is not sheared. In general, a static gel strength measured after 10 min of more than 50 lb/100 ft² (23.95 Pa) is highly undesirable. If the static gel strength becomes too high after resting, it is difficult if not impossible to restart pumping of the cement slurry.

The results depicted in table 1 show that the static gel strength after 10 s and after 10 min for all samples is well below the 50 lb/100 ft² (23.95 Pa) number. Comparative example C2, in which a commercially available polymer powder was used, shows a static gel strength of 161 lb/100 ft² (77.1 Pa) which is far too high. Such a number is fine for the intended use of the product as tile adhesive but highly undesirable for its use in oilwell cementing.

The rheology numbers at shear stress increase with increasing shear stress which a usual behavior of aqueous cement slurries. As a rule, a viscosity of 300 lb/100 ft² (143.7 Pa) should not be exceeded. This is the case for all of the examples and at low shear stress the numbers are well below said limit.

The colloidal stability relates to the dispersibility of the dry polymer powder in the cement formulation. A good dispersibility is important to properly distribute the additive in the cement so that it can act as anti-fluid-loss additive. The two commercial samples C2 and C3 are not dispersible in the cement slurry for cementing oilwells. A comparison between comparative example C1 and example 1 shows the effect of using a combination of surfactant and spray drying aid as compared to using the spray drying agent only. Example 1 shows a good colloidal stability while example C1 shows only a medium colloidal stability.

### Test Series 2

### Thickening Behavior: Measurement of the Static Gel Strength as a Function of Time

For the tests, a Chandler Static Gel Strength Analyzer, Model 5265 was used. Details are described above. The tests were carried out at a temperature of 65.6° C. (150° F.) and a pressure of 358.5*10⁵ Pa (5200 psi).

Polymer powders No. 1, 3, and comparative powder C1 (which does not comprise a surfactant) were used respectively to prepare cement slurries.

For making the cement slurry, the following components were used:

| | | |
|---|---|---|
| 720 | g | Dyckerhoff Class G cement |
| 317 | g | deionized water |
| 3 | g | commercially available silicone defoamer |
| | | (FoamStar ® SI 2201) |
| 64 | g | dry polymer powder as described above |

The components were mixed as described above at ambient temperatures, the slurry transferred into the cement analyzer and static gel strength of the cement slurries measured at 65.6° C. (150° F.) and 358.5*10⁵ Pa (5200 psi) as a function of time.

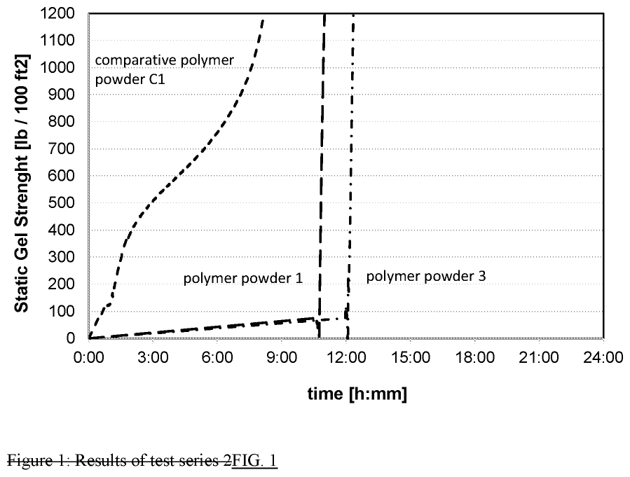

FIG. 1 shows the results of test series 2.

The results show that there is a very pronounced influence of the surfactant on the development of the static gel strength. In comparative example C1, the static gel strength begins to rise directly after mixing the cement slurry and quickly arrives at high values.

In contrast, the static gel strength of the cement slurries comprising powder 1 and powder 3 (which comprise 2 wt. % and 4 wt. % of the surfactant respectively) does not rise significantly for more than 10 h. After about 10:45 h and after about 12:15 h their gel strength starts to rise very rapidly.

So, the cement slurries comprising the polymer powders 1 and 3 are far mor suitable for cementing oil wells than the comparative polymer powder C1: Their static gel strength remains low for a long time, i.e. the slurry remains pumpable and allows properly placing the cement slurry into the annulus between the casing and the wellbore wall.

The rapid increase of the gel strength is very advantageous for another reason: In course of hardening, the cement slurry undergoes a “transition state”. In the transition state, the cement behaves neither as a fluid nor as a solid. The slurry loses its ability to transmit hydrostatic pressure, however gas can still percolate from the formation into the cement which may decrease its strength. A static gel strength of 250 to 500 lb/100 ft² typically is deemed to be sufficient to prevent perlocation. The so-called “transition time” is the time period in which the static gel strength of the cement increases from 100 lb/100 ft² to 500 lb/100 ft², and it should be as short as possible. In test series 2, the two samples according to the present invention show a transition time of 4 min and 14 min, respectively, which in the comparative test 2 h 15 min are needed.

### Test Series 3

### Thickening Behavior: Measurement of the Static Gel Strength as a Function of Time

Test Series 3 was carried out in the same manner as test series 2, however, different polymer samples were tested. The tests aim at showing how the emulsifier may be used.

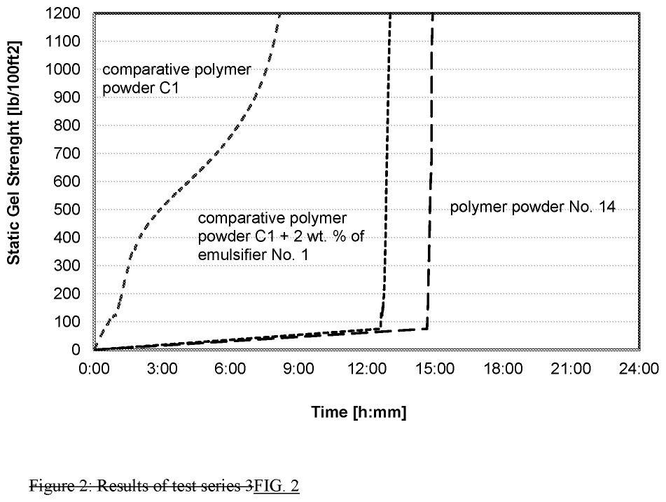

FIG. 2 shows the results of test series 3.

FIG. 2 again shows the data measured for comparative polymer powder No. C1 which shows an insufficient performance.

For another test again comparative polymer powder No. C1 was used, but additionally 2 wt. % of emulsifier No. 1 (relating to the powder C1) were

added to the cement slurry.

Furthermore, polymer powder No. 13 was tested which already comprises 2 wt. % of emulsifier No. 1, which was added before spray-drying the emulsion.

The results again show the very pronounced influence of the emulsifier on the development of the static gel strength. As mentioned above, when using the comparative polymer powder C1 (i.e. a powder not comprising an emulsifier) static gel strength begins to rise directly after mixing the cement slurry and quickly arrives at high values.

When 2 wt.-% of emulsifier No. 1 are added to the cement slurry comprising the comparative polymer powder C1, the gel strength only increases slowly for about 12 hours and thereafter it increases very rapidly. The transition time is very short.

The polymer powder No. 13 which already comprises 2 wt. % of emulsifier No. 1 shows a slightly better performance. The gel strength increases only slowly for about 15 hours and thereafter increases very rapidly. Also here, the transition time is very short.

### Test Series 4

### Thickening Behavior: Measurement of the Consistency as a Function of Time

For test series 4, a Chandler Model 8340 Consistometer was used. Details are described above. The tests were carried out at a temperature of 65.6° C. (150° F.) and a pressure of 358.5*10⁵ Pa (5200 psi).

Polymer powders No. 1 and comparative powder C2 (the commercial product Axilat® PSB 150) were used respectively to prepare cement slurries.

For making the cement slurry, the following components were used:

| | | |
|---|---|---|
| 720 | g | Dyckerhoff Class G cement |
| 317 | g | deionized water |
| 3.04 | g | silicone defoamer (FoamStar ® SI 2201) |
| 64.5 | g | redispersible latex powder |

The cement slurry using the comparative powder C3 was that viscos that it was not possible to transfer the mixture into to the consistometer. No consistency data could be measured.

Therefore, two further tests were carried out:
b) In a first test, the components as mentioned above were used, but additionally 0.61 g lignosulfonate retarder was used.
a) In a second test, the components as mentioned above were used, but additionally 0.61 g lignosulfonate retarder and 4.0 g of melamin condensate dispersant were used.

In both cases, a cement slurry was obtained which was suitable for consistency measurements.

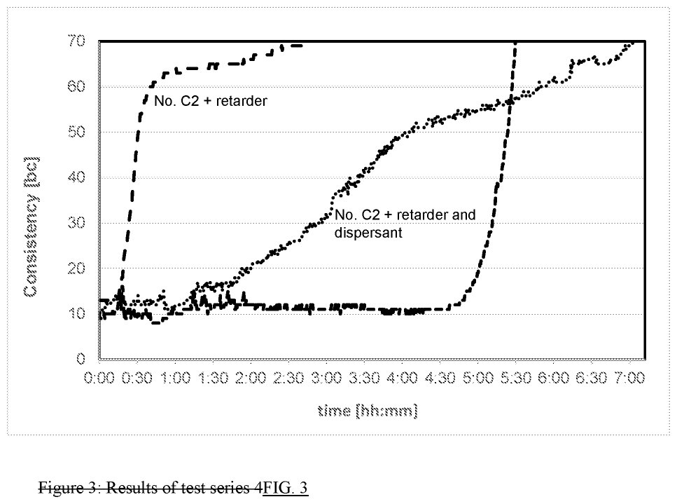

FIG. 3 shows the results of test series 4.

The test with polymer powder No. 1 according to the present invention shows a low consistency of about 10 bc for about 4 h 45 min, so the cement remains pumpable for a long time. Thereafter, the consistency (bc) increases very rapidly. The sample shows a clear rectangular setting behavior.

As already mentioned above, the consistency of the cement slurry comprising the comparative powder C2 was too viscous, so that it already was not possible to transfer the mixture into to the consistometer. However, even when adding additional retarder and additional dispersing agent the resultant cement slurry is not suitable for cementing oilwells. In both cases, the consistency begins to increase already shortly after mixing the cement slurry, so the time window for cementing is too short. Furthermore, in case b) with additional dispersant, the increase of the consistency is no longer steep but the consistency only increases gradually.

### Test Series 5

Rheology tests at room temperature and at 87.8° C. (190° F.) and fluid loss control test results 87.8° C. (190° F.), 121.1° C. (250° F.) and 148.9° C. (300° F.)

The composition of the cement slurries used, the kind and amount of polymer powders used and the results are summarized in tables 2, 3, and 4. The manufacture of the respective polymers powders has already been mentioned above. The cement slurries were used to determine the fluid loss and—for some of the cases—also the rheology.

TABLE 2
Results of fluid loss tests

| | | Test No. 2 | Test No. 3 |
|---|---|---|---|
| Components of Slurry | Test No. 1 | comparative | comparative |
| Class G Cement [g] | 720 | 720 | 720 |
| DI Water [g] | 316.8 | 316.8 | 316.8 |
| Silicone defoamer [g] | 3.04 | 3.04 | 3.04 |
| Melamin condensate | 4.00 | 4.00 | 4.00 |
| dispersant [g] | | | |
| Polymer Powder No. 1 [g] | 64.50 | — | — |
| Polymer Powder No. C1 [g] | — | 64.50 | — |
| Polymer Powder No. C4 [g] | — | — | 64.50 |
| Amount of polymer relating | 8.95% | 8.95% | 8.95% |
| to cement [wt. %] | | | |
| Fluid Loss | 65.5° C. | 65.5° C. | 65.5° C. |
| | (150° F.) | (150° F.) | (150° F.) |
| | 56 ml | 154 ml | 270 ml |

TABLE 3
Results of fluid loss tests (cont.)

| Components of Slurry | | Test No. 4 | | Test No. 5 | | Test No. 6 | | Test No. 7 | | Test No. 8 | |
|---|---|---|---|---|---|---|---|---|---|---|---|
| Class G Cement [g] | | 600 | | 600 | | 600 | | 600 | | 600 | |
| DI Water [g] | | 282.76 | | 282.76 | | 282.76 | | 256.8 | | 256.8 | |
| Silica flour [g] | | 210 | | 210 | | 210 | | 210 | | 210 | |
| Gelling agent | | 0.6 | | 0.6 | | 0.6 | | 1.2 | | 0.6 | |
| Silicone defoamer [g] | | 2.53 | | 2.53 | | 2.53 | | 2.53 | | 2.53 | |
| Melamin condensate dispersant [g] | | 3.33 | | 3.33 | | 3.33 | | 3.33 | | 12 | |
| Lignosulfonate retarder [g] | | 1.31 | | 1.31 | | 1.31 | | 7.2 | | — | |
| Synthetic polymer retarder [g] | | — | | — | | — | | — | | 14.4 | |
| Polymer Powder No. 1 [g] | | 47.74 | | 60.0 | | 66.0 | | 66.0 | | 71.72 | |
| Amount of polymer relating | | 8% | | 10% | | 11% | | 11% | | 12% | |
| to cement [wt.%] | | | | | | | | | | | |
| Fann 35 reading | temperature | RT | 87.8° C. | RT | 87.8° C. | RT | 87.8° C. | RT | 87.8° C. | RT | 87.8° C. |
| [lb/100 ft²] | | | (190° F.) | | (190° F.) | | (190° F.) | | (190° F.) | | (190° F.) |
| | 600 rpm | 290 | 107 | >300 | 105 | >300 | 113 | >300 | 105 | >300 | >300 |
| | 300 rpm | 165 | 60 | 181 | 58 | 209 | 64 | 258 | 58 | >300 | 205 |
| | 200 rpm | 115 | 42 | 128 | 40 | 147 | 44 | 178 | 42 | >300 | 156 |
| | 100 rpm | 62 | 23 | 71 | 22 | 81 | 24 | 94 | 24 | 197 | 99 |
| | 6 rpm | 11 | 3 | 13 | 2 | 13 | 2 | 11 | 4 | 23 | 20 |
| | 3 rpm | 9 | 2 | 11 | 1 | 12 | 1 | 9 | 3 | 1 | 15 |

| Fluid Loss | 87.8° C. (190° F.) | 87.8° C. (190° F.) | 87.8° C. (190° F.) | 121.1° C. (250° F.) | 148.9° C. (300° F.) |
|---|---|---|---|---|---|
| | 130 ml | 70 ml | 60 ml | 24 ml | 22 ml |

TABLE 4
Results of fluid loss tests (cont.)

| Components of Slurry | | Test No. 9 | | Test No. 10 | | Test No. 11 | |
|---|---|---|---|---|---|---|---|
| Class G Cement [g] | | 720 | | 720 | | 720 | |
| DI Water [g] | | 316.80 | | 316.80 | | 316.80 | |
| Silicone defoamer [g] | | 3.04 | | 3.04 | | 3.04 | |
| Polymer Powder No. C1 [g] (without emulsifier) | | 61.6 | | 61.6 | | — | |
| Emulsifier No. 1 [g] | | — | | 1.23 | | — | |
| Polymer Powder No. 13 [g] | | — | | — | | 61.6 | |
| Amount of polymer relating to cement [wt. %] | | 8.6% | | 8.6% | | 8.6% | |
| Fann 35 reading | temperature | RT | 87.8° C. | RT | 87.8° C. | RT | 87.8° C. |
| [lb/100 ft²] | | | (190° F.) | | (190° F.) | | (190° F.) |
| | 600 rpm | 290 | 107 | >300 | 105 | 115 | 65 |
| | 300 rpm | 165 | 60 | 181 | 58 | 59 | 33 |
| | 200 rpm | 115 | 42 | 128 | 40 | 40 | 22 |
| | 100 rpm | 62 | 23 | 71 | 22 | 21 | 11 |
| | 6 rpm | 11 | 3 | 13 | 2 | 2 | 1 |
| | 3 rpm | 9 | 2 | 11 | 1 | 1 | 0 |

| Fluid Loss | 87.8° C. (190° F.) | 87.8° C. (190° F.) | 87.8° C. (190° F.) |
|---|---|---|---|
| | 345 ml* | 154 ml | 74 ml |

*number calculated as shown above, due to “blow out” of test sample

The results in tables 2 to 4 demonstrate the advantage of the powders according to the present invention as compared to other powders.

Polymer powder No. 1 according to the present invention (Test No. 1, table 2) gives rise to of fluid loss of 56 ml. In contrast, the comparative polymer powder No. C1 (Test No. 2, table 2) which has been prepared in the same manner, except that the surfactant was not used, gives rise to a fluid loss of 154 ml which is significant more. The commercial powder No. 4 (Test No. 3, table 2), which is based on a styrene-acrylics copolymer and which is suggested as additive for tile adhesives gives rise to a fluid loss of 270 ml, which is completely insufficient. The product is not suitable as fluid-loss additive.

The results in table 3 (tests No. 4 to No. 8) show, that with increasing amounts of the polymer powder No. 1 the amount of fluid-loss decreases.

The results in table 4 (tests No. 9 to No. 11) show, how the emulsifier influences the fluid loss. Test No. 9 was carried out with polymer powder No. C1, i.e. a polymer powder comprising no surfactant. The fluid loss of 345 ml was calculated as shown above because of a “blow out”, i.e. nitrogen blew through the test sample.

Adding 2 wt. % of emulsifier No. 1 polymer powder No. C1 (test No. 10) yields a fluid loss of only 154 ml, i.e. the fluid loss is reduced by more than 50% as compared to test No. 9. However, using polymer powder No. 13 (test No. 11), which was prepared by adding 2 wt. % of emulsifier No. 1 before spray-drying yields a fluid loss of only 74 ml, which again is more than 50% less than in test No. 10.

So, using a polymer powder without emulsifier and adding an emulsifier separately to the cement slurry, has an effect on the fluid loss, but the fluid loss is significantly lower when the emulsifier is included in the polymer powder by adding it to the polymer dispersion before spray-drying.

1-20. (canceled)

21. A water-dispersible polymer powder composition (P) for use as additive in cementing in subterranean formations comprising at least
50 to 98.5 wt.-% of particles of a styrene-butadiene polymer (A),
1 to 20 wt.-% of at least one water-soluble polymer (B), selected from the group of phenol sulfonic acid—formaldehyde condensates, naphthalene sulfonic acid—formaldehyde condensates, melamine-formaldehyde condensates, formaldehyde-acetone-sulfite condensates, and copolymers comprising at least ethylenically unsaturated monomers comprising sulfonic acid groups and ethylenically unsaturated monomers comprising carboxylic acid groups,
0.5 to 10 wt.-% of at least one non-ionic emulsifier (C),
wherein the amounts relate to the total of all components of the composition (P), and
wherein the styrene-butadiene polymer particles are at least partly covered by and/or embedded in a composition (X) comprising at least the water-soluble polymer (B).

22. The water-dispersible polymer powder composition (P) according to claim 21, wherein the composition (X) comprises the non-ionic emulsifier(s) (C).

23. The water-dispersible polymer powder composition (P) according to claim 21, wherein the composition (P) is a mixture of the non-ionic emulsifier(s) (C) and styrene-butadiene polymer particles (A) which are at least partly covered by and/or embedded in a composition (X).

24. The water-dispersible polymer powder composition (P) according to claim 21, wherein the composition (P) comprises additionally up to 30 wt.-% of an anti-blocking agent(s) (D), wherein the amount relates to the total of all components of the composition (P).

25. The water-dispersible polymer powder composition (P) according to claim 21, wherein the non-ionic emulsifier (C) has the general formula
R¹—O—(CH₂—CHR²O)ₙH,
wherein R¹ is a linear or branched aliphatic hydrocarbon moiety comprising 12 to 20 carbon atoms, R² is selected from the group of H, methyl and ethyl, wherein at least 50% of all R² groups are H, and n is from 15 to 50.

26. The water-dispersible polymer powder composition (P) according to claim 21, wherein the water-soluble polymers comprise at least phenol sulfonic acid-form-aldehyde condensates.

27. The water-dispersible polymer powder composition (P) according to claim 27, comprising,
60 to 96 wt.-% of the particles of the styrene-butadiene polymer (A),
1 to 15 wt.-% of at the water-soluble polymer(s) (B),
1 to 7 wt.-% of non-ionic emulsifier(s) (C), and
1 to 20 wt. % of anti-blocking agent(s) (D),
wherein the amounts relate to the total of all components of the composition (P).

28. The water-dispersible polymer powder composition (P) according to claim 27, comprising,
70 to 90 wt.-% of the particles of the styrene-butadiene polymer (A),
3 to 12 wt.-% of at the water-soluble polymer(s) (B), comprising at least a phenol sulfonic acid—formaldehyde condensate,
1 to 5 wt.-% of non-ionic emulsifier(s) (C), having the formula R¹—O—(CH₂—CHR²)ₙH,
wherein R¹, R², and n have the meaning as defined, and
5 to 15 wt. % of anti-blocking agent(s) (D),
wherein the amounts relate to the total of all components of the composition (P).

29. A process for making a water-dispersible polymer powder composition (P) according to claim 21, comprising spray-drying an aqueous polymer dispersion in the presence of a spray-drying aid, wherein process comprises at least the following process steps:
(1) providing an aqueous dispersion for spray-drying (S) by mixing at least an aqueous polymer dispersion comprising particles of a styrene-butadiene polymer (A), and
a spray-drying aid which comprises at least one water-soluble polymer (B), selected from the group of phenol sulfonic acid-formaldehyde condensates, naphthalene sulfonic acid-formaldehyde condensates, melamine-formaldehyde condensates, formaldehyde-acetone-sulfite condensates, and copolymers comprising at least ethylenically unsaturated monomers comprising sulfonic acid groups and ethylenically unsaturated monomers comprising carboxylic acid groups, and
(2) spray-drying the resultant aqueous dispersion (S),
wherein at least one non-ionic emulsifier (C) is added to the aqueous dispersion for spray-drying (S), and/or mixed with the spray-dried product after spray drying.

30. The process according to claim 29, wherein the non-ionic emulsifier (C) is added to the aqueous dispersion for spray-drying (S).

31. The process according to claim 29, wherein the non-ionic emulsifier (C) is mixed with the spray-dried product after spray drying.

32. The process according to claim 29, wherein at least one anti-blocking agent (D) is added during and/or after spay-drying, wherein the amount of the anti-blocking agent(s) is up to 30 wt.-%, relating to the total of all components of the composition (P).

33. The process according to claim 29, wherein the non-ionic emulsifier (C) has the general formula
R¹—O—(CH₂—CHR²O)ₙH,
wherein R¹ is a linear or branched aliphatic hydrocarbon moiety comprising 12 to 20 carbon atoms, R² is selected from the group of H, methyl and ethyl, wherein at least 50% of all R² groups are H, and n is from 15 to 50.

34. The process according to claim 29, wherein the water-soluble polymers comprise at least phenol sulfonic acid—formaldehyde condensates.

35. A method comprising utilizing the water-dispersible polymer powder composition (P) according to claim 21 for cementing in subterranean formations penetrated by at least a well bore comprising at least the following steps:
(a) preparing an aqueous cement slurry by mixing at least a hydraulic cement, a water-dispersible polymer powder composition (P) according to claim 21, and sufficient water to form a pumpable slurry;
(b) placing said aqueous cement slurry through a well bore to a zone to be cemented, and
(c) allowing said aqueous cement slurry to set.

36. The method according to claim 35, wherein the amount water-dispersible polymer powder composition (P) is from 8 to 15 wt.-%, relating to the cement.

37. A dry cement composition comprising at least
a hydraulic cement, and
a water-dispersible polymer powder composition (P) according to claim 21.

38. The dry cement formulation according to claim 37, wherein the amount water-dispersible polymer powder composition (P) is from 8 to 15 wt.-%, relating to the cement.

39. The method according to claim 35, wherein the water-dispersible powder composition (P) and the hydraulic cement are comprised in a dry cement composition, and wherein in step (a) the aqueous cement slurry is prepared by mixing at least the dry cement composition and sufficient water, to form the pumpable slurry.

40. A method comprising utilizing a water-dispersible polymer powder composition (P1) comprising at least
50 to 99 wt.-% of particles of a styrene-butadiene polymer (A),
1 to 20 wt.-% of at least one water-soluble polymer (B), selected from the group of phenol sulfonic acid—formaldehyde condensates, naphthalene sulfonic acid—formaldehyde condensates, melamine-formaldehyde condensates, formaldehyde-acetone-sulfite condensates, and copolymers comprising at least ethylenically unsaturated monomers comprising sulfonic acid groups and ethylenically unsaturated monomers comprising carboxylic acid groups,
up to 30 wt.-% of at least one anti-blocking agent (D),
wherein the amounts relate to the total of all components of the composition (P1), and
wherein the styrene-butadiene polymer particles are at least partly covered by and/or embedded in a composition (X) comprising at least the water-soluble polymer (B),
for cementing in subterranean formations penetrated by at least a well bore, comprising at least the following steps:
(a) preparing an aqueous cement slurry by mixing at least a hydraulic cement, the water-dispersible polymer powder composition (P1), and sufficient water to form a pumpable slurry;
(b) placing said aqueous cement slurry through a well bore to a zone to be cemented; and
(c) allowing said aqueous cement slurry to set,
wherein additionally 0.5 to 10 wt.-% of at least one non-ionic emulsifier (C) are added to the aqueous cement slurry.
